(19) United States
(12) Patent Application Publication
(10) Pub. No.: US 2015/0226251 A1
(43) Pub. Date: Aug. 13, 2015

(54) ASSEMBLY HAVING TWO COMPONENTS COUPLED WITH FASTENING MEMBER

(71) Applicant: Caterpillar Inc., Peoria, IL (US)

(72) Inventors: Robert M. Stengl, Locust Grove, GA (US); Nader W. Ktami, Griffin, GA (US)

(73) Assignee: Caterpillar Inc., Peoria, IL (US)

(21) Appl. No.: 14/696,533

(22) Filed: Apr. 27, 2015

(51) Int. Cl. F16B 37/04

(52) U.S. Cl. CPC F16B 37/045

(57) ABSTRACT

The present disclosure is related to an assembly for coupling a first member and a second member. The first member includes a lower portion defining a hole having a central axis therethrough. The second member includes an upper portion having a mounting aperture and an access aperture. Further, the assembly includes an elongate fastener configured to be at least partially received in the hole and the mounting aperture. The assembly also includes a fastening member having a nut and a tab. The nut and the elongate member are aligned with the central axis and threadingly coupled to each other. The tab engages with the walls of the access aperture to prevent rotation of the nut during coupling. The tab also projects through the access aperture when the nut is aligned with the central axis.

### TECHNICAL FIELD

The present disclosure relates to an assembly having a first member coupled to a second member, and more particularly to a fastening member for coupling the first member to the second member.

### BACKGROUND

Machines such as, a generator sets, generally require two base members to be coupled to each other by a bolt and nut assembly. Typically, the nut is welded to one of the base members in blind locations that may be difficult to access. For example, one of the base members may include a channel and the nut may be provided within the channel. In case the nut sustains any damage during assembly, the base member may have to be disassembled for getting access to the nut for repair or replacement. Further, such a repair or replacement process may not be possible onsite and requires transportation of the components to another location. Therefore, the process may be time consuming and cost intensive.

For reference, WO Patent Publication 96/41960 (the '960 publication) discloses mounting bolts) for securing a first component, typically a vehicle door latch unit, to a second component, typically an interior structural member of a vehicle door. The mounting bolts are provided with a threaded stem screwed through tappings of the first component and heads which are inserted, on assembly, through keyhole or the like in the second component. The outwardly directed free ends of the bolts have drive formations, for example “Allen” type hexagon sockets engageable by a drive tool for screwing the components together. However, the assembly of the '960 publication may not allow access to the tappings of the first component in case the tappings are provided in a location having limited or no access. Hence, any repair or replacement of the tappings may require disassembly of the first component.

### SUMMARY OF THE DISCLOSURE

In one aspect of the present disclosure, an assembly for retaining a fastening member having limited or no access to the fastening member is provided. The assembly includes a first member, a second member, an elongate fastener and a fastening member. The first member includes a lower portion that defines a hole. The hole defines a central axis. The second member is configured to be detachably coupled to the first member. The second member further includes an upper portion configured to receive the lower portion of the first member thereon. The upper portion defines a mounting aperture, which is configured to be aligned with the hole of the first member along the central axis. Further, the upper portion defines an access aperture having a first edge located proximal to the mounting aperture and a second edge distal to the mounting aperture. The first edge is located at a first distance from the central axis such that the access aperture is spaced apart from the lower portion of the first member. The elongate fastener is configured to be at least partially received in the hole of the first member and the mounting aperture of the second member. The fastening member includes a nut configured to be aligned with the mounting aperture of the second member along the central axis. The nut is further configured to be threadingly engaged with the elongate fastener to detachably couple the first member to the second member. The fastening member also includes a tab rigidly connected to and extending from the nut, and configured to be at least partly inserted through the access aperture of the second member. The tab has an end distal to the nut. Further, a second distance between the end of the tab and the central axis is greater than the first distance between the first edge of the access aperture and the central axis such that the tab projects through the access hole when the nut is aligned with the mounting aperture of the second member. Moreover, the tab is structured and arranged to engage with walls of the access aperture to prevent rotation of the nut about the central axis during threaded engagement of the nut with the elongate fastener.

Other features and aspects of this disclosure will be apparent from the following description and the accompanying drawings.

### BRIEF DESCRIPTION OF THE DRAWINGS

FIG. 1 is a partial perspective view of an assembly having a first member and a second member in an uncoupled state, according to an embodiment of the present disclosure;

FIG. 2 is an enlarged view of an encircled portion 2-2 of FIG. 1 illustrating an access aperture of the second member;

FIG. 3 is a sectional view along a line X-X′ in FIG. 1, according to an embodiment of the present disclosure;

FIG. 4 is a perspective view of a fastening member of the assembly, according to an embodiment of the present disclosure;

FIG. 5 is a sectional view of the first member and the second member illustrating the fastening member partially inserted within the access aperture of the second member;

FIG. 6 is a sectional view of the first member and the second member illustrating coupling of a nut of the fastening member with an elongate fastener;

FIG. 7 is a sectional view of the first member and the second member of FIG. 1 in an assembled state;

FIG. 8 is an enlarged perspective view of the first member and the second member in the assembled state;

FIG. 9 shows a perspective view of the fastening member, according to another embodiment of the present disclosure; and

FIG. 10 shows a perspective view of the fastening member, according to yet another embodiment of the present disclosure;

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

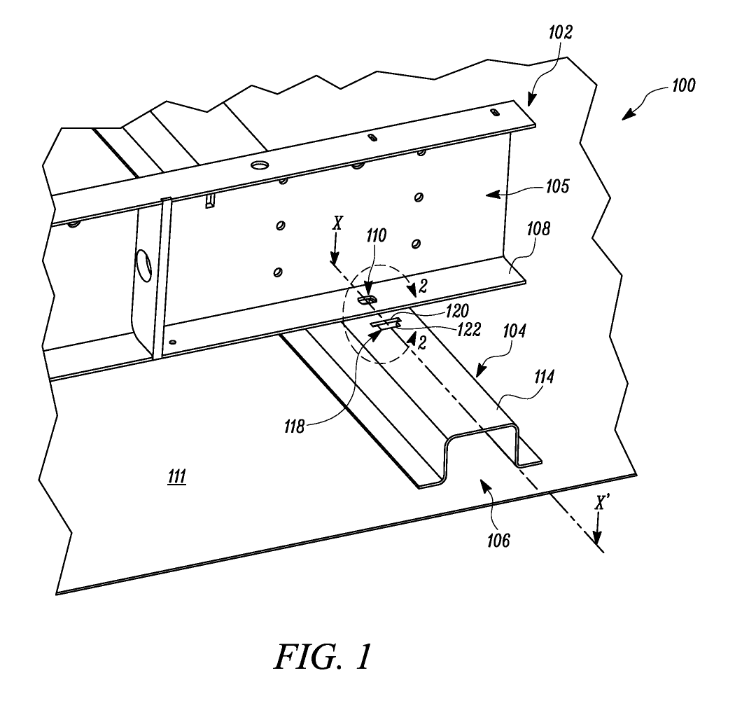

FIG. 1 shows a perspective view of an exemplary assembly 100 having a first member 102 and a second member 104. In an example, the assembly 100 may be a part of a machine. The machine may be, for example, a generator set having an engine (not shown) drivably coupled to a generator (not shown). In an embodiment, the assembly 100 may be part of a base supporting the engine and the generator. Further, the engine and the generator may be mounted on the first member 102. The first member 102 defines a first channel 105. In the illustrated embodiment, the first channel 105 is substantially C-shaped. The first member 102 also includes a lower portion 108 defining a lower part of the first channel 105. The first member 102 is mounted over the second member 104. The second member 104 defines a second channel 106. In the illustrated embodiment, the second channel 106 is substantially hat-shaped. The second member 104 also includes an upper portion 114 which defines an upper part of the second channel 106 The upper portion 114 is configured to receive the lower portion 108 of the first member 102 thereon.

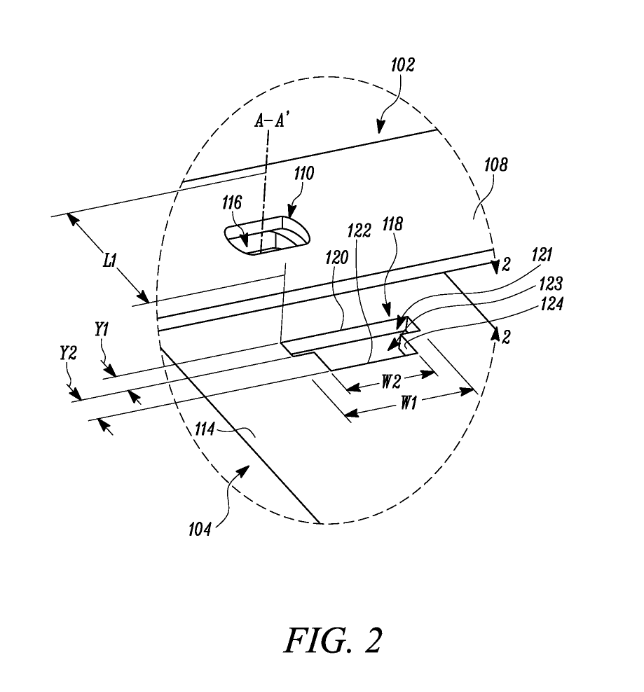

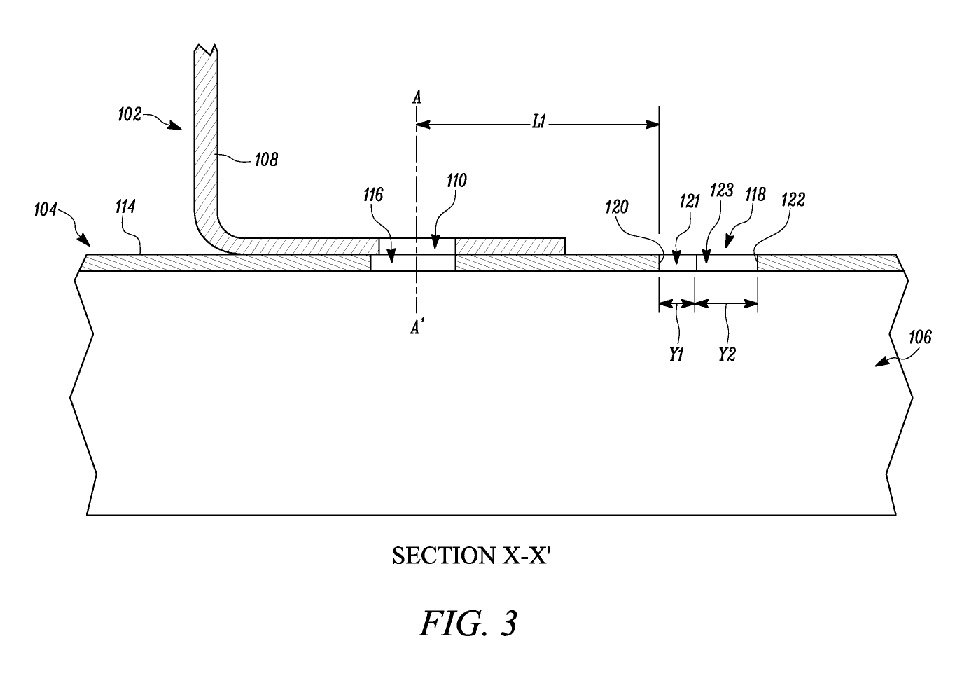

FIG. 2 illustrates an enlarged view of the encircled portion 2-2 of FIG. 1. FIG. 3 illustrates a sectional view along the line X-X′ in FIG. 1. Referring to FIGS. 2 and 3, the lower portion 108 of the first member 102 defines a hole 110 therethrough. The hole 110 defines a central axis A-A′ therethrough. The second member 104 includes an upper portion 114. The upper portion 114 of the second member 104 defines a mounting aperture 116 therethrough. The mounting aperture 116 is configured to be aligned with the hole 110 of the first member 102 along the central axis A-A′. In an embodiment the mounting aperture 116 may be of varying shapes and not limited to a circle, square, rectangle, oval and the like.

The second member 104 further defines an access aperture 118 spaced apart from the mounting aperture 116. The access aperture 118 includes a first edge 120 and a second edge 122. The first edge 120 is proximal to the mounting aperture 116 and the second edge 122 is distal to the mounting aperture 116. The first edge 120 is located at a first distance “L1” from the central axis A-A′. The first distance “L1” is such that the access aperture 118 is spaced apart from the lower portion 108 of the first member 102. Hence, the access aperture 118 is not covered by the lower portion 108 and accessible after the first member 102 is mounted on the second member 104.

The access aperture 118 also includes a first aperture portion 121 and a second aperture portion 123. The first aperture portion 121 is proximate to the mounting aperture 116, while the second aperture portion 123 is distal to the mounting aperture 116. The first aperture portion 121 has a length “Y1” and a width “W1”. The second aperture portion 123 has a width “W2” which is less than the width “W1” of the first aperture portion 121. However, a length “Y2” of the second aperture portion 123 is greater than the length “Y1” of the first aperture portion 121. The access aperture 118 further includes walls 124 of substantially uniform depth to define the first aperture portion 121 and the second aperture portion 123. Further, the walls 124 also define the first edge 120 and the second edge 122 of the access aperture 118. In the illustrated embodiment, the first and second aperture portions 121, 123 are substantially rectangular. However, the first and second aperture portions 121, 123 may have alternate shapes within the scope of the present disclosure, for example, oblong, elliptical, and the like. Further, the dimensions of the first and second aperture portions 121, 123 may also change as per requirements. Moreover, it may also be contemplated that the access aperture 118 may only have a single portion having any suitable shape, such as rectangular, oblong, elliptical, and the like.

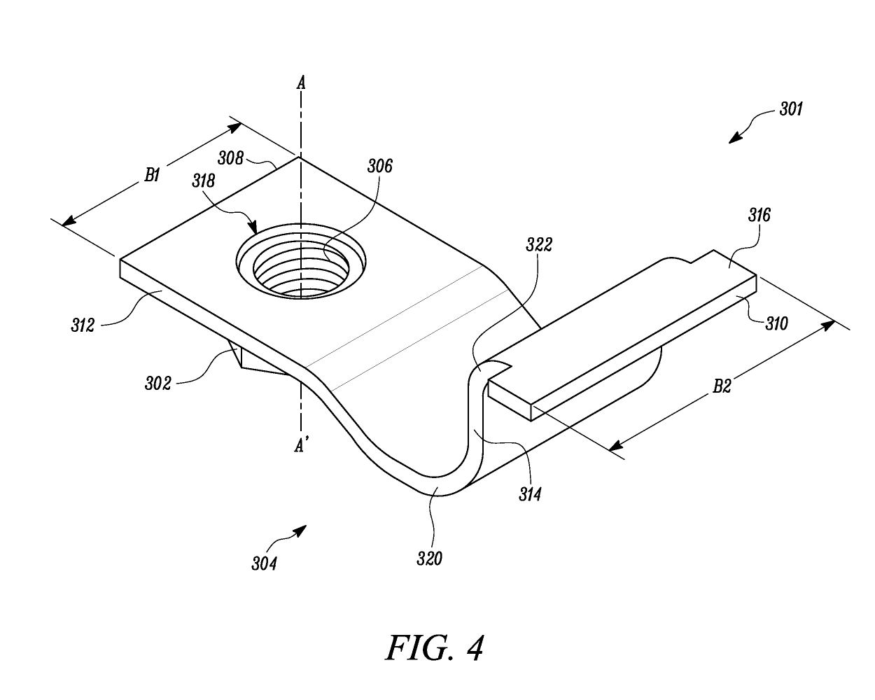

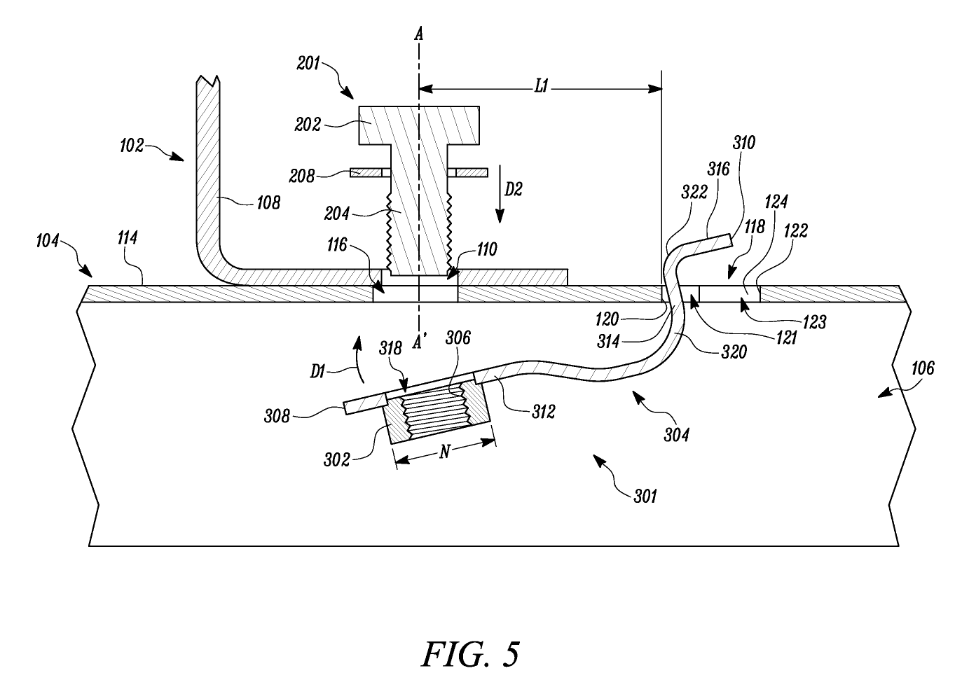

FIG. 4 shows a perspective view of a fastening member 301, according to an embodiment of the present invention. FIG. 5 shows the fastening member 301 at least partially inserted within the access aperture 118 of the second member 104. Reference will also be made from FIGS. 2 and 3. The fastening member 301 includes a nut 302 and a tab 304 rigidly connected and extending from the nut 302. The nut 302 includes an inner portion 306 having threads configured to threadingly engage with a threaded portion 204 of an elongate fastener 201. In the illustrated embodiment, the elongate fastener 201 is a bolt with a head portion 202 adjacent to the threaded portion 204. Further, the nut 302 has a width “N” (shown in FIG. 3) which may be less than the width “W2” of the second aperture portion 123 such that the nut 302 may be inserted through the second aperture portion 123.

The tab 304 may be a metal plate configured to at least partly inserted through the access aperture 118 of the second member 104. The tab 304 further includes a first end 308 proximal to the nut 302 and a second end 310 distal to the nut 302. The width of the first end 308 may be “B1”. The width “B1” of the first end 308 may be less than the width “W1” of the first aperture portion 121 such that there may be a clearance between the walls 124 of the access aperture 118 and the tab 304. Further, the tab 304 includes a first portion 312 attached to the nut 302, a second portion 314 adjacent to the first portion 312 and a third portion 316 adjacent to the second portion 314.

The first portion 312, as illustrated in FIG. 4, defines a tab hole 318. The nut 302 and the tab hole 318 may be coaxially aligned. The nut 302 may be coupled to the first portion 312 via various methods, such as welding, adhesives, press-fitting, and the like. The first portion 312 further has a curvilinear section 320 distal to the nut 302. The curvilinear section 320 may aid in maneuvering the nut 302 to coaxially align with the mounting aperture 116 and the hole 110 along the central axis A-A′. The first portion 312 also has the width “B1” similar to the first end 308. The second portion 314 extends from the curvilinear section 320 in a direction parallel to the central axis A-A′ when the nut 302 is aligned along the central axis A-A′. The second portion 314 may also engage with the walls 124 of the first aperture portion 121 of the access aperture 118. The second portion 314 also has the width “B1” similar to the first end 308. In an embodiment, the width “B1” may be less than the width “W2” of the second aperture portion 123 of the access aperture 118. Therefore, the second portion 314 may be retained within the first aperture portion 121, and the walls 124 may prevent sliding movement of the second portion 314 into the second aperture portion 123 of the access aperture 118. The third portion 316 of the tab 304 extends from the second portion 314 along a direction perpendicular to the central axis A-A′ when the nut 302 is aligned along the central axis A-A′. Further, the third portion 316 includes a width “B2” greater than the width “B1”. The third portion 316 may be configured to be gripped in order to facilitate movement of the tab 304 with respect to the access aperture 118. Further, it may be apparent from FIG. 4 that the second portion 314 and the nut 302 extend in substantially opposite directions with respect to the first portion 312. Moreover, a bent portion 322 is provided between the second and third portions 314, 316 to provide a smooth transition.

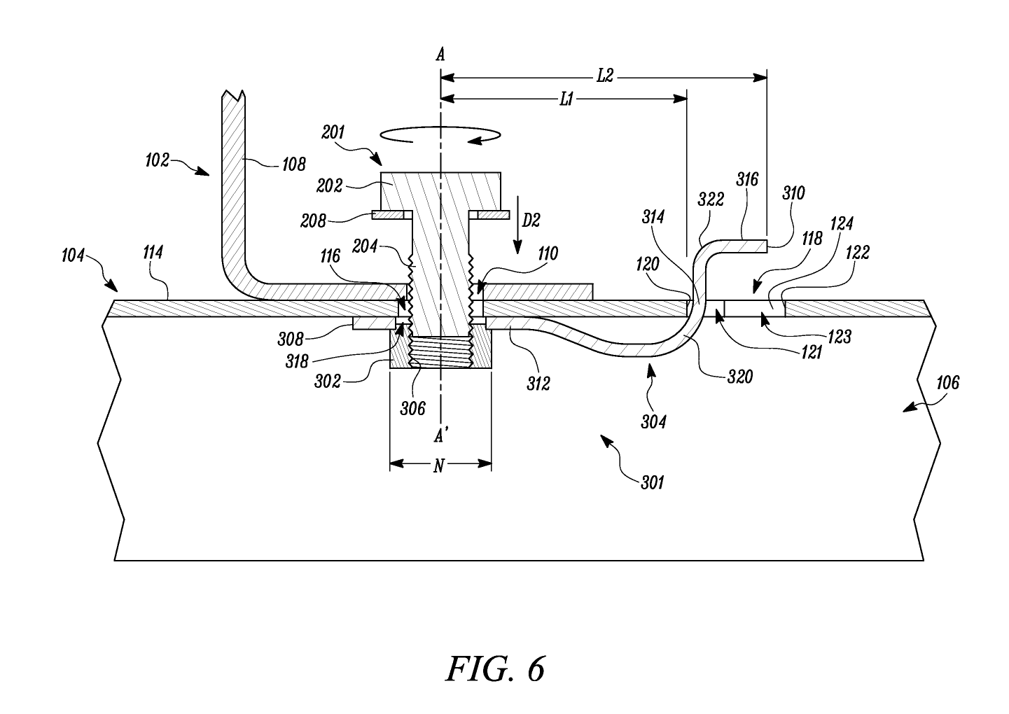

Referring to FIG. 5, the fastening member 301 is partially inserted within the first aperture portion 121 of the access aperture 118 such that the first portion 312 of the tab 304 along with the nut 302 is disposed within the second channel 106 of the second member 104. The lengths “Y1” and “Y2” (shown in FIGS. 2 and 3) of the first and second aperture portions 121, 123, respectively, of the access aperture 118 may enable insertion of the first portion 312 along with the nut 302. Specifically, during insertion, the first portion 312 is located proximate to the first edge 120 of the access aperture 118, while the nut 302 is located proximate to the second edge 122 of the access aperture 118. Further, the curvilinear section 320 may facilitate movement of the nut 302 along a direction “D1” such that the nut 302 may be aligned with the central axis A-A′, as shown in FIG. 6. The threaded portion 204 of the elongate fastener 201 is configured to be at least partially received within the hole 110 and the mounting aperture 116 along a direction “D2” parallel to the central axis A-A′. The threaded portion 204 of the elongate fastener 201 is slidably coupled to a washer 208.

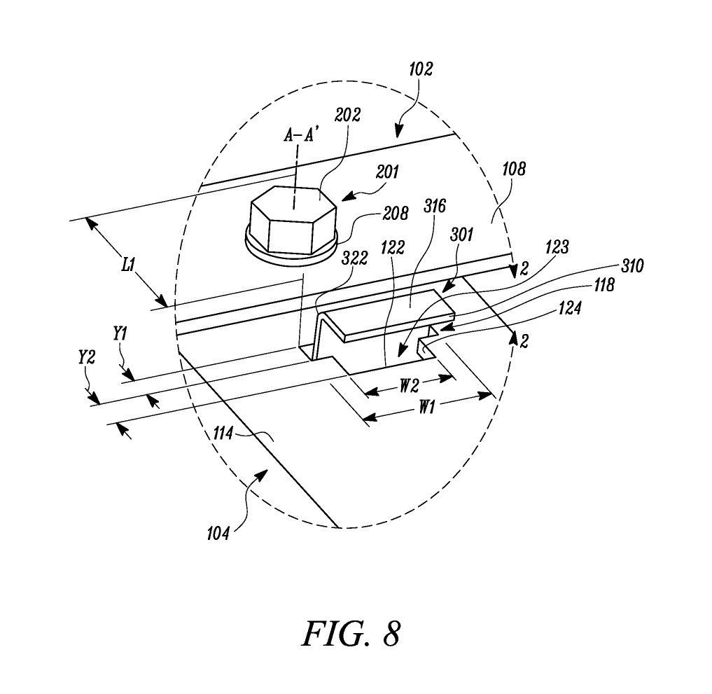

FIG. 6 illustrates coupling of the elongate fastener 201 with the nut 302 after alignment with the central axis A-A′. The head portion 202 of the elongate fastener 201 may facilitate rotation of the elongate fastener 201 about the central axis A-A′ via a tool. The washer 208 may be placed between the head portion 202 and the first member 102 for load distribution. As a result, the threaded portion 204 of the elongate fastener 201 may be threadably engaged with the inner portion 306 of the nut 302. As illustrated in FIG. 6, the second end 310 of the tab 304 is located at a second distance “L2” with respect to the central axis A-A′. The second distance “L2” is greater than the first distance “L1”, such that the second end 310 of the tab 304 projects through the access aperture 118 when the nut 302 is aligned with the mounting aperture 116. Further, referring to FIGS. 6 and 8, the second portion 314 of the tab 304 may be structured and arranged to engage with the walls 124 of the first aperture portion 121 of the access aperture 118 in order to prevent rotation of the nut 302 about the axis A-A′during threaded engagement of the nut 302 with the elongate fastener 201. Specifically, the clearance between the second portion 314 of the tab 304 and the walls 124 may allow limited movement of the tab 304 during tightening. However, rotation of the tab 304 and the nut 302 about the central axis A-A′ may be restricted due to the rectangular shape of the first aperture portion 121. Moreover, the second portion 314 may be retained in the first aperture portion 121 as the width “B1” of the second portion 314 is greater than the width “W2” of the second aperture portion 123.

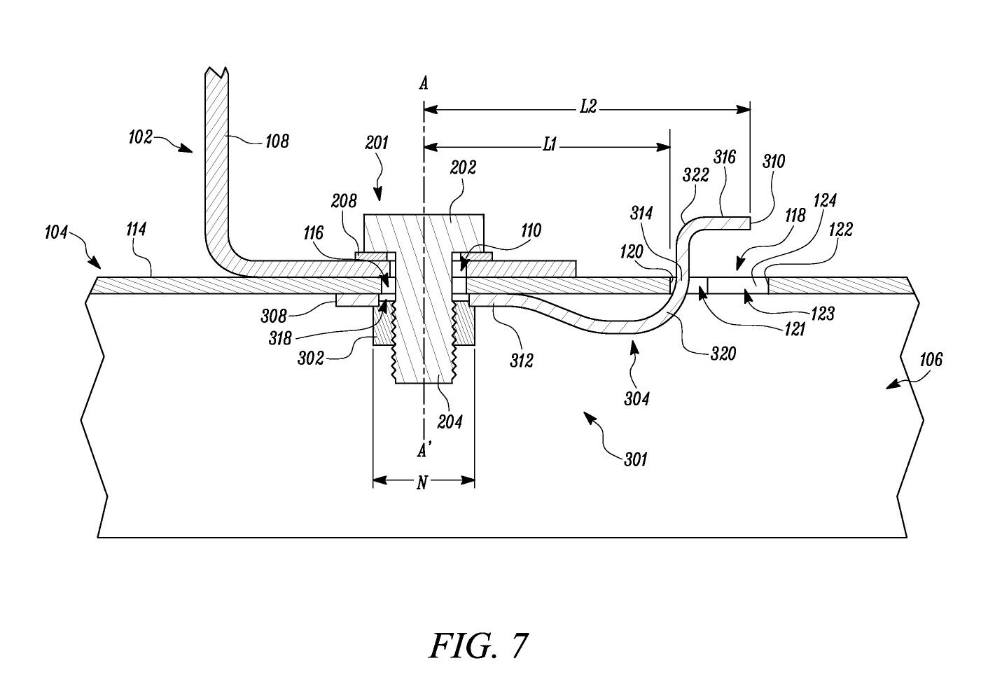

FIGS. 7 and 8 illustrate the first and second members 102, 104 in an assembled state. Specifically, the elongate fastener 201 is threadably engaged with the nut 302 to detachably couple the first and second members 102, 104 to each other. In the assembled state, the head portion 202 of the elongate fastener 201 projects from the hole 110 of the first member 102. Further, the second portion 314 of the tab 304 is retained within the first aperture portion 121 of the access aperture 118. In case the nut 302 is required to be removed from the assembly 100, the head portion 202 of the elongate fastener 201 may be rotated to disengage the threaded portion 204 of the elongate fastener 201 from the nut 302. The engagement of the second portion 314 with the walls 124 may prevent rotation of the nut 302 about the central axis A-A′ during disengagement. After disengagement, the third portion 316 of the tab 304 may be gripped to remove the tab 304 along with the nut 302 from the access aperture 118 in a manner opposite to the insertion of the fastening member 301.

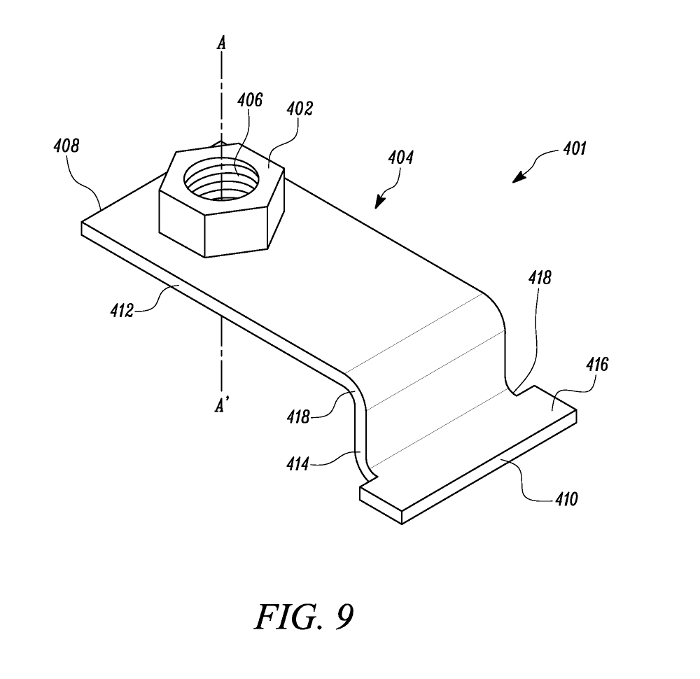

FIG. 9 illustrates a fastening member 401, according to another embodiment of the present disclosure. Similar to the fastening member 301 described above, the fastening member 401 includes a nut 402 and a tab 404. An inner portion 406 of the nut 402 has threads. Further, the tab 404 includes a first end 408 proximal to the nut 402 and a second end 410 distal to the nut 402. The tab 404 includes a first portion 412 attached to the nut 402, a second portion 414 adjacent to the first portion 412 and a third portion 416 adjacent to the second portion 414. In an embodiment, the first portion 412 may be substantially perpendicular to the second portion 414. The third portion 416 may be substantially perpendicular to the second portion 414. Moreover, bent portions 418 may be provided between the first and second portions 412, 414, and the second and third portions 414, 416. The bent portions 418 provide a smooth transition between adjacent portions of the tab 404. Further, the third portion 416 may have a width greater than a width of the first or second portions 412, 414. The nut 402 and the second portion 414 also extend in substantially opposite directions with respect to the first portion 412.

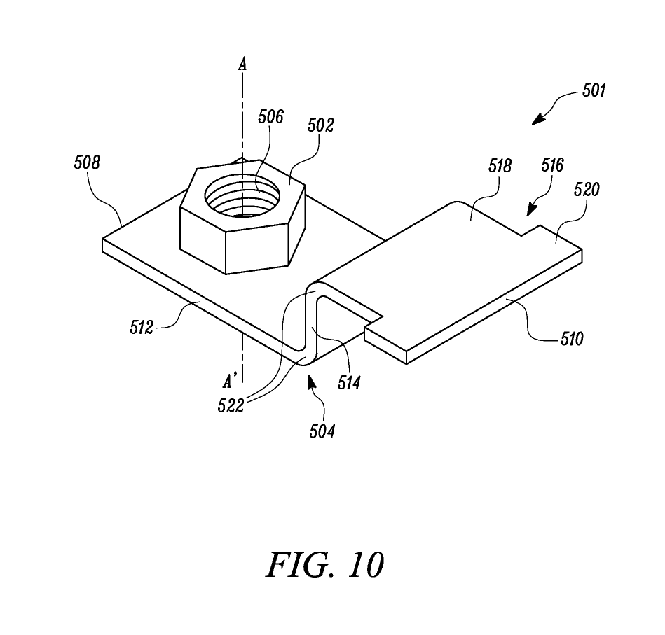

FIG. 10 illustrates a fastening member 501, according to yet another embodiment of the present disclosure. Similar to the fastening member 401 of FIG. 9, the fastening member 501 includes a nut 502 and a tab 504. The nut 502 includes an inner portion 506 having threads. Further, the tab 504 includes a first end 508 proximal to the nut 502 and a second end 510 distal to the nut 502. The tab 504 includes a first portion 512 attached to the nut 502, a second portion 514 adjacent to the first portion 512 and a third portion 516 adjacent to the second portion 514. In an embodiment, the first portion 512 may be substantially perpendicular to the second portion 514. The third portion 416 may be substantially perpendicular to the second portion 414. Further, the third portion 516 has two sections 518, 520 having different widths. Specifically, the section 520 proximate the second end 510 may have a width greater than a width of the section 518. Moreover, bent portions 522 may be provided between the first and second portions 512, 514, and the second and third portions 514, 516. The bent portions 522 provide a smooth transition between adjacent portions of the tab 504. Moreover, in contrast to the fastening member 401, the nut 502 and the second portion 514 of the fastening member 501 extend in substantially similar directions with respect to the first portion 512.

### INDUSTRIAL APPLICABILITY

The present disclosure relates to an assembly 100 having one or more of the fastening members 301, 401 and 501 that are configured to detachably couple the first member 102 and the second member 104 of the assembly 100. The tabs 304, 404 and 504 of the respective fastening members 301, 401, 501 may enable removal of the respective nuts 302, 402 and 502 from the second channel 106 despite the second channel 106 providing limited or no access to the nuts 302, 402 and 502. Specifically, if the nuts 302, 402 and 502 require any repair or replacement due to any damage during assembly or operation, the respective tabs 304, 404 and 504 enable fast and convenient removal of the nuts 302, 402 and 502 without the need for disassembly of the second member 104 or any additional tools. Further, the repair or replacement process may be carried out onsite without requiring transportation of any components to another location. Hence, time, cost and complexity of the repair or replacement process may be reduced. The tabs 304, 404 and 504 may also be reused after the repair or replacement process.

The first aperture portion 121 of the access aperture 118 may also allow limited movement of the tabs 304, 404 and 504, thereby reducing tolerance requirements of the access aperture 118 as well and the mounting aperture 116. For example, the access aperture 118 may allow for slight variations of the first distance “L1” (shown in FIG. 3) between the first edge 120 and the central axis A-A′.

Each of the fastening members 301, 401 and 501 may also be used with different configurations of the first member 102 and the second member 104. For example, the fastening members 301, 401 and 501 may be used for different distances and/or heights between the mounting aperture 116 and the access aperture 118. Further, the assembly 100 may include multiple sets of the hole 110, the mounting aperture 116, and the access aperture 118.

Though the present disclosure has been described with reference to the first and second members 102, 104, it may be contemplated that the fastening members 301, 401 and 501 may be used in coupling any two components where there is limited or no access to the respective nuts 302, 402 and 502. Further, assembly using the fastening members 301, 401 and 501 may be part of any machine, such as but not limited to, generator sets, excavators, locomotives, loaders, dozers, off-highway trucks, and the like.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. An assembly for retaining a fastening member having limited or no access to the fastening member, the assembly comprising:
a first member comprising a lower portion defining a hole therethrough, the hole defining a central axis therethrough;
a second member configured to be detachably coupled to the first member, the second member comprising an upper portion configured to receive the lower portion of the first member thereon, the upper portion defining:
a mounting aperture therethrough, the mounting aperture being configured to be aligned with the hole of the first member along the central axis; and
an access aperture having a first edge located proximal to the mounting aperture and a second edge distal to the mounting aperture, wherein the first edge is located at a first distance from the central axis such that the access aperture is spaced apart from the lower portion of the first member;
an elongate fastener configured to be at least partially received in the hole of the first member and the mounting aperture of the second member; and
the fastening member comprising:
a nut configured to be aligned with the mounting aperture of the second member along the central axis, the nut further configured to be threadingly engaged with the elongate fastener to detachably couple the first member to the second member; and
a tab rigidly connected to and extending from the nut, and configured to be at least partly inserted through the access aperture of the second member, the tab having an end distal to the nut, wherein a second distance between the end of the tab and the central axis is greater than the first distance between the first edge of the access aperture and the central axis such that the tab projects through the access aperture when the nut is aligned with the mounting aperture of the second member, and wherein the tab is structured and arranged to engage with walls of the access aperture to prevent rotation of the nut about the central axis during threaded engagement of the nut with the elongate fastener.
